(19) United States
(12) Patent Application Publication
(10) Pub. No.: US 2006/0076379 A1
(43) Pub. Date: Apr. 13, 2006

(54) Portable travel cooler/warmer container

(75) Inventors: Saied Hussaini, Miami, FL (US); Marc Iacovelli, Miami, FL (US)

Correspondence Address: BERENATO, WHITE & STAVISH, LLC, 6550 ROCK SPRING DRIVE, SUITE 240, BETHESDA, MD, 20817, US

(73) Assignee: RALLY MANUFACTURING INC.

(21) Appl. No.: 10/962,549

(22) Filed: Oct. 13, 2004

(51) Int. Cl. B60R 7/00

(52) U.S. Cl. 224/275; 224/539; 224/511

(57) ABSTRACT

A portable cooler/warmer that can be securely fastened to a seat or to a floor in a vehicle. The cooler/warmer comprises a container body defining a storage compartment and an opening therein, and a releasable seat belt pass-through latch assembly provided on the container body for releasably engaging a seat belt of the vehicle for securing the container body to the vehicle. The releasable seat belt pass-through latch assembly is provided at a bottom portion of the container body and includes a latch member pivotally mounted relative to the container body for releasably engaging the container body. The latch member is formed with a seat belt channel provided for supporting the seat belt in the seat belt pass-through latch assembly and is formed on an inner surface of the latch member facing the container body. The cooler/warmer further includes a refrigeration/heating unit powered by a rechargeable electrical battery.

### BACKGROUND OF THE INVENTION

1. Field of the Invention

The present invention is related to portable cooler/warmer containers in general, and more specifically to a portable cooler/warmer container adapted to be used in a vehicle for securing to a vehicle seat by a seat belt.

2. Description of the Prior Art

Conventionally, storage containers used on a vehicle have a certain mechanism for fastening the storage container onto a vehicle seat as they are liable to drop off the seat in the worst case due to the shifting inside the vehicle that is caused by an inertia force developed in stepping on a brake during the driving or taking a curve at an intersection or at a street corner. The prior art often proposes to provide an extension member including a block-shaped fastening body on a rear side of the storage container. The fastening body is inserted into between a backrest and a sitting seat to clamp the fastening body there between, thereby fastening the storage container on the seat.

However, as the fastening body is simply clamped between a backrest and a sitting seat according to the conventional in-car storage container, the fastening body is liable to come off between the backrest and the sitting seat if a large inertial force is applied thereto when stepping on a brake or taking a curve at an intersection or a street corner, thus leading to a risk that the storage container itself falls down or even tumbles within a car in the worst case. Such phenomenon is particularly noticeable because an inertial force applied to the storage container becomes large if it stores a large amount of food stuffs, or if it is integrated with a heavy component such as a built-in refrigerator. Particularly if such storage container is tumbled inside a car, it would be extremely dangerous.

With this in mind, a need exists to develop an improved portable storage container for use in a vehicle that advances the art.

### SUMMARY OF THE INVENTION

The present invention provides a novel portable storage container, such as a cooler/warmer container, which can be securely fastened to a seat or to a floor in a vehicle.

The portable storage container in accordance with the present invention comprises a container body defining a storage compartment and an opening therein, a lid member provided for enclosing said opening of said container body, and a releasable seat belt pass-through latch assembly provided on the container body for releasably engaging a seat belt of the vehicle for securing the container body to the vehicle. The releasable seat belt pass-through latch assembly is provided at a bottom portion of the container body and includes a latch member pivotally mounted relative to the container body for releasably engaging the container body. The latch member is formed with a seat belt channel provided for supporting the seat belt in the seat belt pass-through latch assembly and is formed on an inner surface of the latch member facing the container body.

The portable storage container in accordance with the present invention further comprises at least one mount bracket for mounting the container body to the vehicle. Preferably, the at least one mount bracket is retractable between stowed position and an operating position so that the at least one mount bracket in the stowed position is disposed within the container body. Furthermore, the container body has at least one groove track retractably receiving the at least one mount bracket for sliding movement between the stowed position and the operating position, wherein the groove track is formed in a bottom portion of the container body.

### BRIEF DESCRIPTION OF THE DRAWINGS

Other objects and advantages of the invention will become apparent from a study of the following specification when viewed in light of the accompanying drawings, wherein:

FIG. 1 is a side view of a portable cooler/warmer container in accordance with a preferred embodiment of the present invention;

FIG. 2 is a top view of the portable cooler/warmer container in accordance with the preferred embodiment of the present invention;

FIG. 3 is a top view of a container body in accordance with the preferred embodiment of the present invention;

FIG. 4 is a front view of the portable cooler/warmer container in accordance with the preferred embodiment of the present invention;

FIG. 5 is a top view of the container body in accordance with the preferred embodiment of the present invention with removed lid and cover members;

FIG. 6 is a front view of the portable cooler/warmer container in accordance with the preferred embodiment of the present invention showing in phantom lines internal compartments, an electrical battery and a vehicle seat belt pass-through latch;

FIG. 7 is a left side view of the portable cooler/warmer container in accordance with the preferred embodiment of the present invention;

FIG. 8 is a right side view of the portable cooler/warmer container in accordance with the preferred embodiment of the present invention;

FIG. 9 is a right side view of the portable cooler/warmer container in accordance with the preferred embodiment of the present invention with removed right side panel;

FIG. 10 is an enlarged view A of the FIG. 6;

FIG. 11 is an enlarged view B of the FIG. 9;

FIG. 12 is a bottom view of the portable cooler/warmer container in accordance with the preferred embodiment of the present invention;

FIG. 13 is an enlarged view D of the FIG. 12.

### DETAILED DESCRIPTION OF PREFERRED EMBODIMENTS

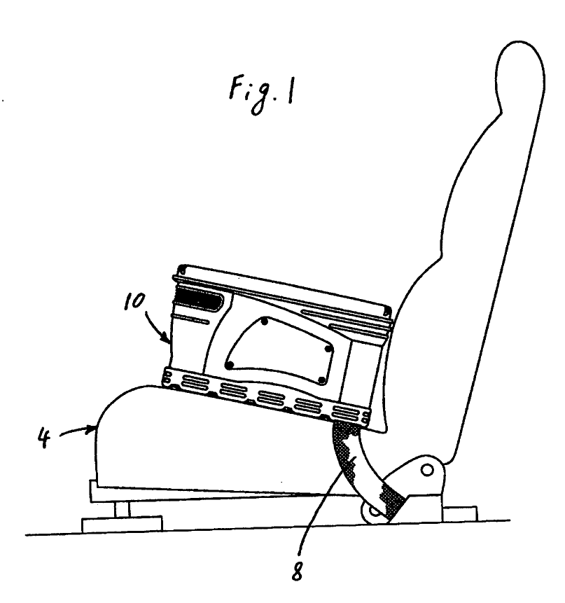

The preferred embodiment of the present invention will now be described with the reference to accompanying drawings. For purposes of the following description, the terms “upper”, “lower”, “top”, “bottom”, “upward”, “downward”, “vertical”, “horizontal” and derivatives of such terms shall relate to the invention as oriented in FIG. 1. However, it is to be understood that the invention may assume various alternative orientations, except where expressly specified to the contrary. It is also to be understood that the specific article illustrated in the attached drawings, and described in the following specification is simply exemplary embodiment of the inventive concept. Specific dimensions and other physical characteristics relating to the embodiment disclosed herein are not to be considered as limiting, unless expressly stated otherwise.

Hereinafter is described a preferred exemplary embodiment of the invention with reference to FIGS. 1-9. In the following description, a portable cooler/warmer container is taken as an example of an in-car storage container of the present invention.

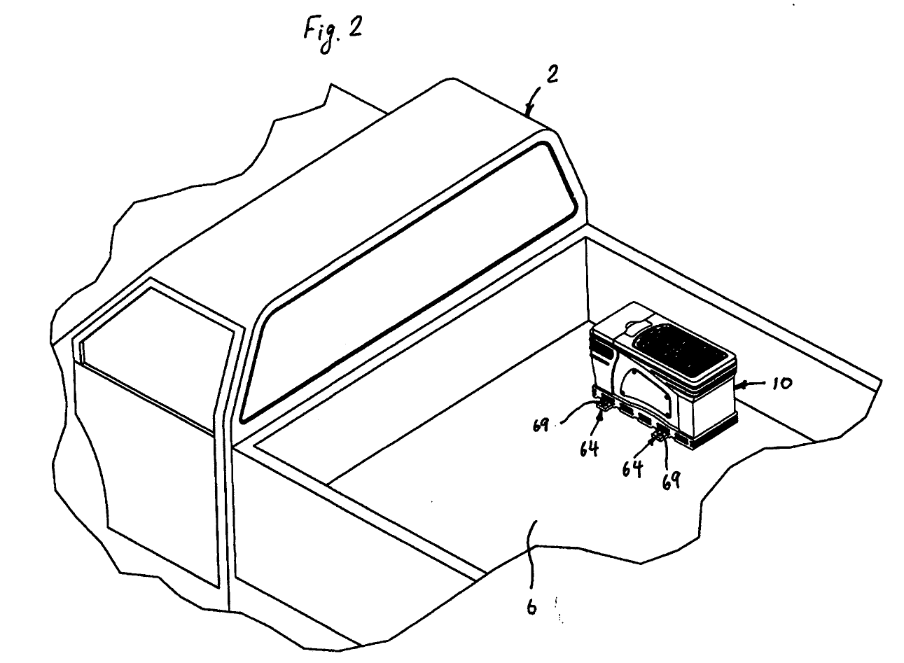

FIGS. 1 and 2 depict the portable cooler/warmer container in accordance with a preferred embodiment of the present invention, generally labeled with the reference numeral 10, which can be securely fastened to a vehicle 2, such as to a seat 4 or to a floor 6 of the vehicle 2.

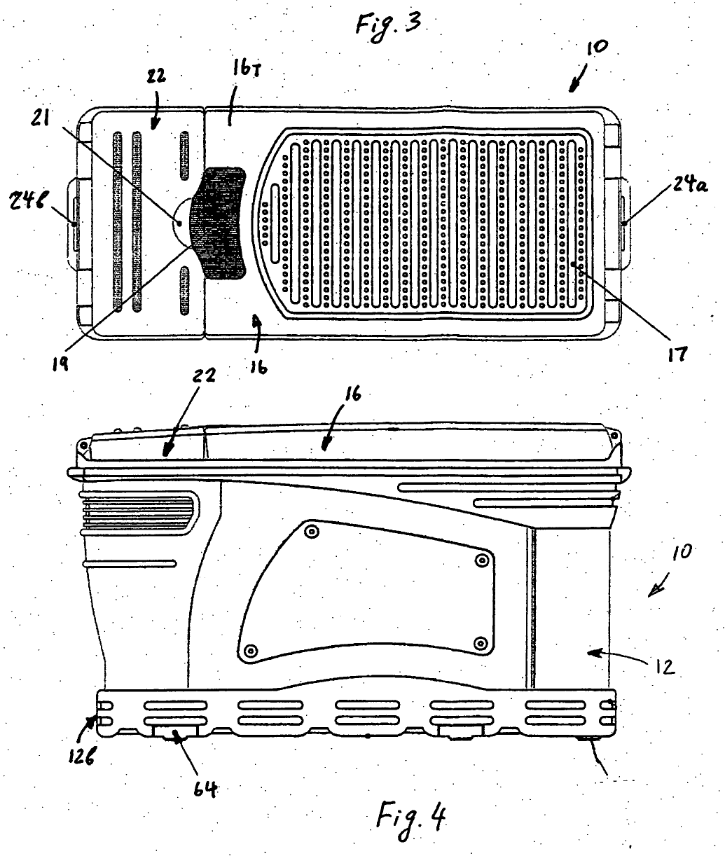

As illustrated in detail in FIGS. 3-8, the portable cooler/warmer container 10 comprises a container body 12 defining a storage compartment 14 (shown in FIG. 5) and a lid member 16 for closing the storage compartment 14. The container body 12 has a bottom portion 12b provided with a rubber-coated outer peripheral surface 12c.

A seal member 15 is provided around an opening 14a in the storage compartment 14 to reduce heat exchange between the storage compartment 14 and the ambient air. As illustrated in FIG. 5, the lid member 16 is attached to the container body 12 through a nylon strap 23a. Alternatively, the lid member 16 may be pivotally attached to the container body 12 through an appropriate hinge member. The lid member 16 is provided with a lid latch 19 to keep lid member 16 normally in a closed position. As illustrated in FIG. 3, a top surface 16_{T} of the lid member 16 is provided with a tray pad 17.

The container body 12 further includes a cup holder tray 18 removably covered with a cover member 22 attached to the container body 12 through a nylon strap 23b. Again, alternatively, the cover member 22 may be pivotally attached to the container body 12 through an appropriate hinge member. The cover member 22 is formed with a finger clearance (recess) 21 providing a space for inserting fingers of a user to engage the lid latch 19 of the lid member 16.

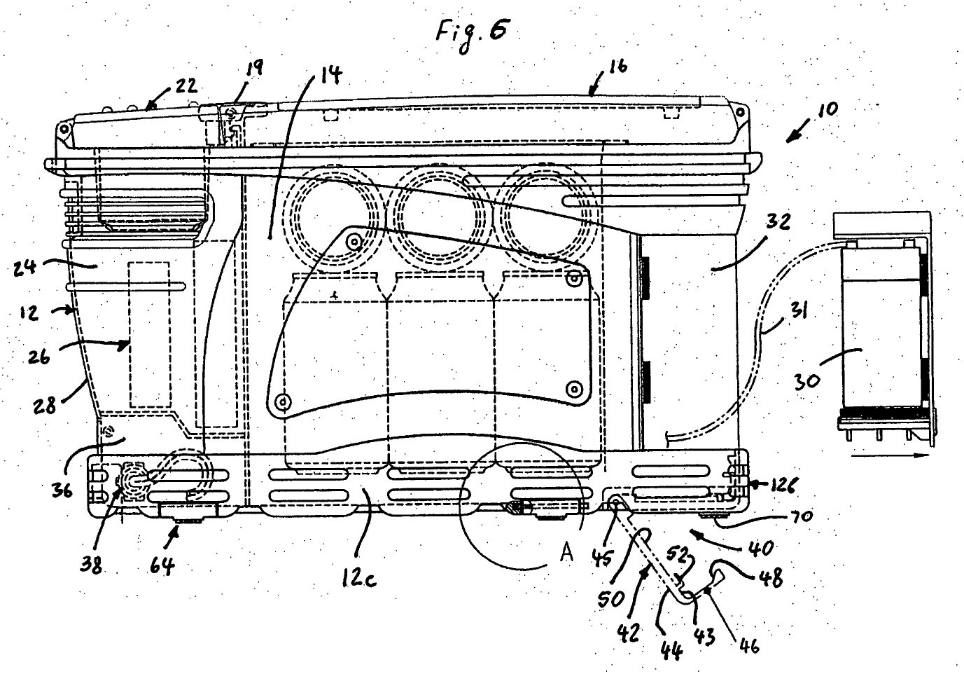

As illustrated in FIG. 6, the container body 12 further includes a machine compartment 24 adapted to house a refrigeration/heating unit 26. The refrigeration/warmer unit 26 can be any refrigerating and/or heating machine which, preferably, is supplied energy from electrical batteries 30 disposed in a battery compartment 32 also defined within the container body 12 (also shown in FIG. 9). For example, the refrigeration/heating unit 26 can be of any know type such as a compression refrigerating machine, an adsorber refrigerating machine, a heat pump, etc. As an example, the refrigeration/warmer unit 26 can be similar to the refrigerating unit disclosed in U.S. Pat. No. 5,168,718 incorporated herein by reference. The electrical batteries 30 are connected to the refrigeration/heating unit 26 through an electrical cable 31. Preferably, the electrical batteries 30 are rechargeable.

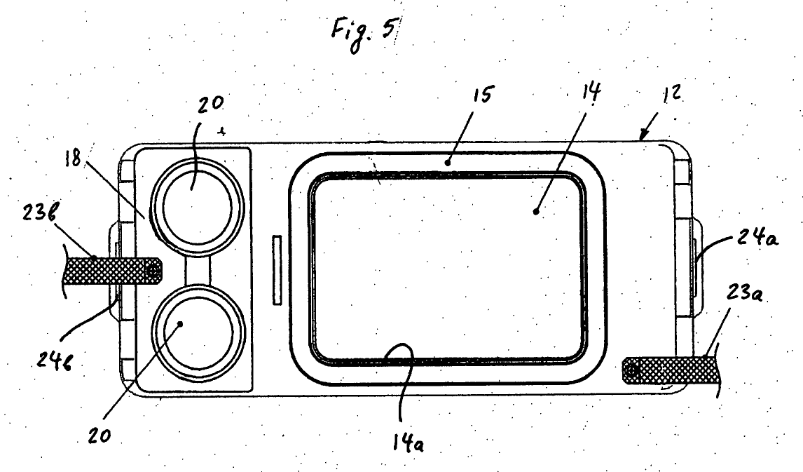

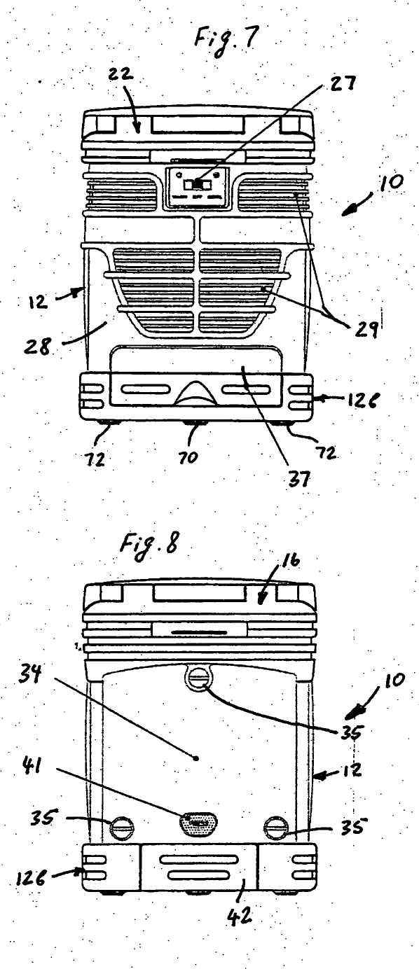

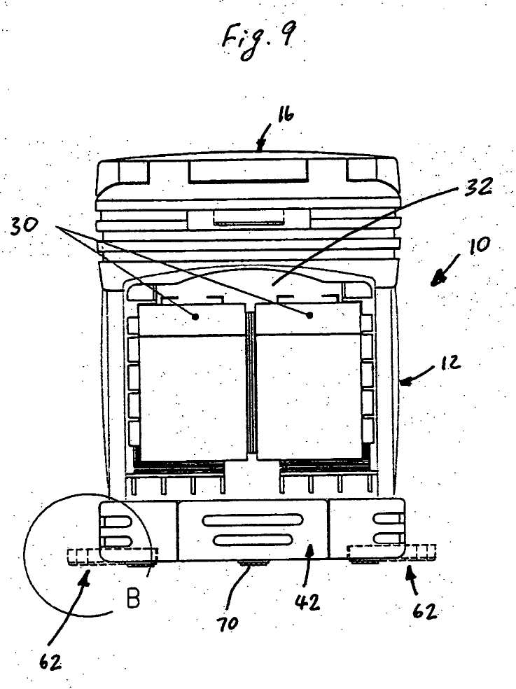

The machine compartment 24 within the container body 12 is covered by a left side panel 28 (as viewed in FIGS. 4 and 6), while the battery compartment 32 is covered by a right side panel 34. As further illustrated in detail in FIG. 7, the left side panel 28 is provided with cooling vents 29 and a control switch 27 for operating the refrigeration/heating unit 26. As illustrated in detail in FIG. 8, the right side panel 34 is removably secured to the container body 12 with a set of threaded fasteners 35.

As illustrated in FIG. 6, the container body 12 further includes a plug compartment 36 adapted to house a car adaptor/a rechargeable battery DC plug 38. According to the preferred embodiment of the present invention, the power to run the refrigeration/heating unit 26 is supplied via the car adaptor 38 located in the compartment 36. Also, the rechargeable electrical batteries 30 can be charged using the DC adaptor. The plug compartment 36 is covered by a plug cover 37, as shown in FIG. 7.

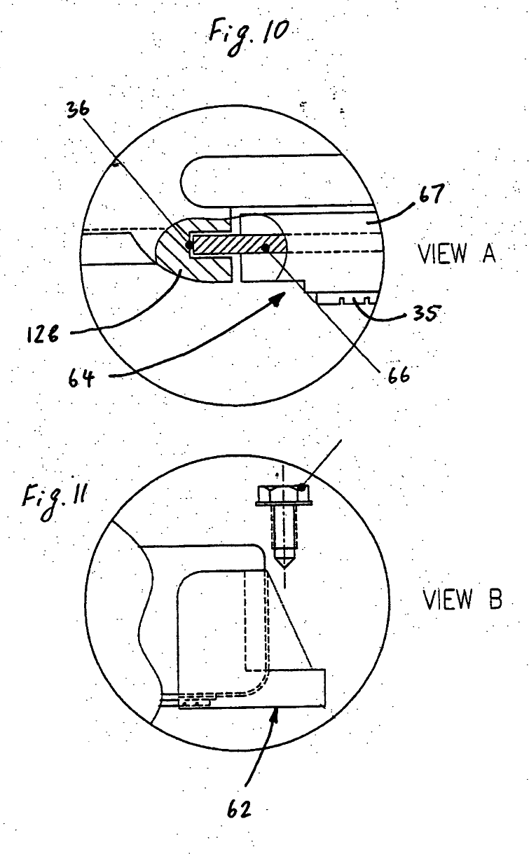

The portable cooler/warmer container of the present invention further comprises a releasable seat belt pass-through latch assembly 40 provided for removably securing a vehicle seat belt 8 (shown in FIGS. 1 and 10) to the container body 12. Preferably, the seat belt fastener assembly 40 is formed at the bottom portion 12b of the container body 12. The seat belt fastener assembly 40 includes a generally L-shaped latch member 42 releasably engaging a locking portion provided on the container body 12, an a release button 41 extending through the right side panel 34 as shown in FIG. 8. The latch member 42 has a generally planar main portion 44 and a latch portion 46 extending from a distal end of the main portion 44 substantially perpendicularly thereto. The proximal end of the main portion 44 is pivotally attached to the bottom portion 12b of the container body 12 through a hinge 45 for pivotal movement between a closed position when the latch member 42 lockingly engages the container body 12, and an open position (shown in FIG. 4 in phantom line). The latch portion 46 is carrying a lug 48 adapted to engage a complementary rib formed in the container body 12 in order to lockingly engages the container body 12 in the closed position.

As further illustrated in detail in FIG. 6, the latch member 42 defines a seat belt channel, or groove, 50 provided for supporting the seat belt 8 in the seat belt fastener assembly 40. The seat belt channel 50 is formed on an inner surface 43 of the latch member 42 facing the container body 12. The seat belt channel 50 is defined at a rear end thereof by an L-shaped guide member, or hook, 52 formed on the inner surface 43 of the main portion 44 of the latch member 42 and protruding away from the latch portion 46 and toward the hinge 45. Preferably, the guide member 52 formed integrally with the latch member 42 as a single-piece part.

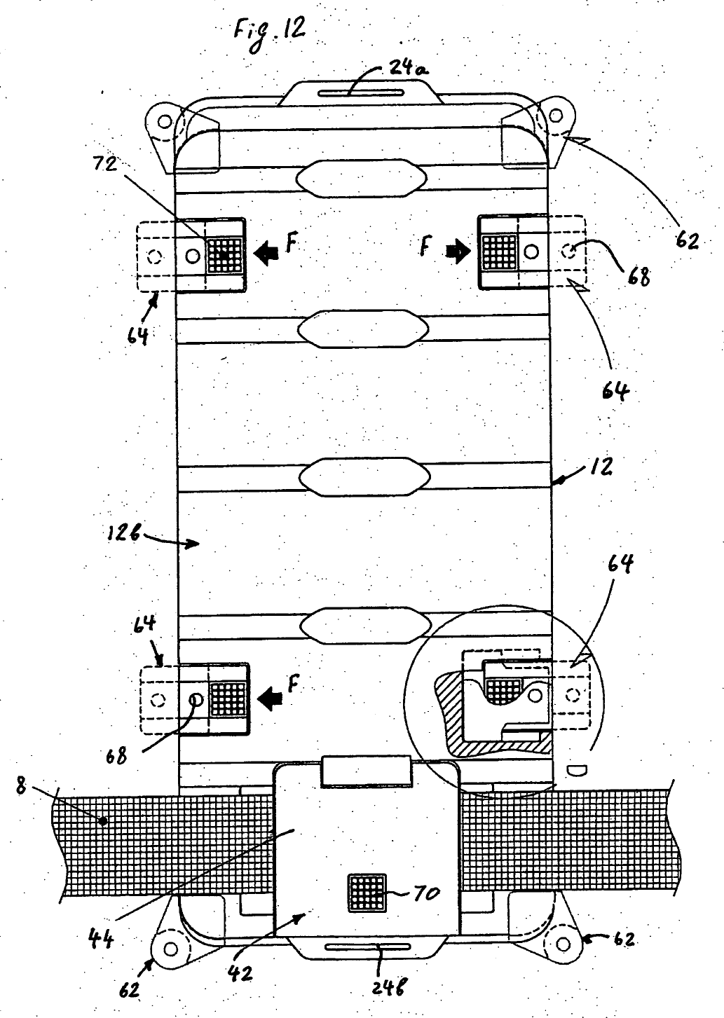

As further illustrated in detail in FIGS. 6 and 12, an outer surface of the main portion 44 of the latch member 42 is provided with a rubber pad 70 assisting to frictional stability of the container 10 on a support surface within the vehicle.

In operation, in order to secure the portable cooler/warmer container 10 to the vehicle, e.g. to the seat 4 of the vehicle, first, the seat belt latch assembly 40 is released by pressing the release button 41, and the latch member 42 is placed in the open position. Then, the seat belt 8 is positioned in the seat belt channel 50 so that the seat belt 8 is engaged the guide member 52. After that, the latch member 42 is moved to the closed position wherein the lug 48 of the latch member 42 lockingly engages the complementary rib of the container body 12. As a result, the seat belt 8 of the vehicle is releasably fastened to the cooler/warmer container 10 (as shown in FIG. 12) and the cooler/warmer container 10 is reliably secured to the vehicle. Preferably, the cooler/warmer container 10 is secured by the seat belt 8 to a vehicle seat 4 (as illustrated in FIG. 1).

The container body 12 is further provided with at least one mount bracket for mounting the container 12 to the vehicle. In accordance with the preferred embodiment of the present invention, the container body 12 is provided with a plurality of the mount brackets including four corner mount brackets 62 disposed at each corner of the container body 12 (as shown in FIGS. 9, 11 and 12), and a plurality, preferably four, side mount brackets 64.

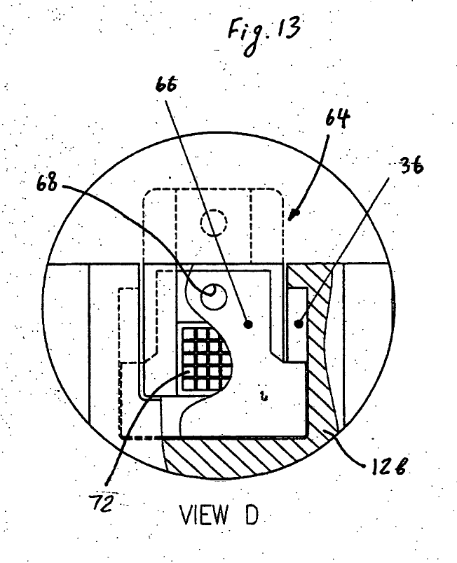

The side mount brackets 64 are retractably mounted to the bottom portion 12b of the container body 12 between a stowed position (shown in FIGS. 12 and 13 in solid lines) and an operating (or deployed) position (shown in FIGS. 12 and 13 in phantom line). As further illustrated in FIGS. 12 and 13, each of the side mount brackets 64 includes a reinforcement plate 66 slideably mounted within groove track 36 formed at the bottom portion 12b of the container body 12 for sliding movement between the stowed position and the operating position. Preferably, the reinforcement plate 66 is made of metal and is embedded into a plastic support member 67. In order to move the side mount brackets 64 from the stowed position to the deployed position, the side mount brackets 64 are manually pushed into the direction of arrows F, as shown in FIG. 12.

Each of the side mount brackets 64 has a mounting hole 68 provided for receiving a mounting fastener 69, such as bolt or screw, securing the container 10 to an appropriate portion of the vehicle 2, such the floor 4 of cargo compartment of the van or pickup truck, as shown in FIG. 2. Each of the side mount brackets 64 is further provided with a rubber pad 72 assisting to frictional stability of the container 10 on a support surface within the vehicle 2.

Therefore, the portable cooler/warmer container in accordance with the present invention represents a novel and improved arrangement of a portable container having a releasable seat belt pass-through latch assembly and at least one mount bracket retractable between a stowed position and an operating position.

The foregoing description of the preferred embodiment of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

What is claimed is:

1. A portable storage container provided to be used in a vehicle, said portable storage container comprising:
a container body defining a storage compartment and an opening therein;
a lid member provided for enclosing said opening of said container body; and
a releasable seat belt pass-through latch assembly provided on said container body for releasably engaging a seat belt of the vehicle for securing said container body to the vehicle.

2. The portable storage container as defined in claim 1, wherein said releasable seat belt pass-through latch assembly is provided at a bottom portion of said container body.

3. The portable storage container as defined in claim 1, wherein said releasable seat belt pass-through latch assembly includes a latch member pivotally mounted relative to said container body for releasably engaging said container body.

4. The portable storage container as defined in claim 3, wherein said latch member is formed with a seat belt channel provided for supporting the seat belt in said seat belt pass-through latch assembly.

5. The portable storage container as defmed in claim 4, wherein said seat belt channel is formed on an inner surface of said latch member facing said container body.

6. The portable storage container as defined in claim 5, wherein said seat belt channel is defined at a rear end thereof by an L-shaped guide member formed on said inner surface of said latch member.

7. The portable storage container as defined in claim 3, wherein said latch member is movable between a closed position wherein the seat belt is engaged between said latch member and said container body, and an open position provided for inserting and removing the seat belt.

8. The portable storage container as defined in claim 3, wherein said container body further includes a release button provided to release said latch member from said container body.

9. The portable storage container as defined in claim 1, wherein said container body further includes at least one mount bracket for mounting said container body to the vehicle.

10. The portable storage container as defined in claim 9, wherein said at least one mount bracket is retractable between stowed position and an operating position; and wherein said at least one mount bracket in said stowed position is disposed within said container body.

11. The portable storage container as defined in claim 10, wherein said container body has at least one groove track retractably receiving said at least one mount bracket for sliding movement between said stowed position and said operating position, said at least one groove track is formed in a bottom portion of said container body.

12. A portable storage container provided to be used in a vehicle, said portable storage container comprising:
a container body defining a storage compartment and an opening therein;
a lid member provided for enclosing said opening of said container body; and
at least one mount bracket for mounting said container body to the vehicle, said at least one mount bracket is retractable between stowed position and an operating position.

13. The portable storage container as defmed in claim 12, wherein said at least one mount bracket in said stowed position is disposed within said container body.

14. The portable storage container as defmed in claim 13, wherein said container body has at least one groove track retractably receiving said at least one mount bracket for sliding movement between said stowed position and said operating position.

15. The portable storage container as defined in claim 14, wherein said at least one groove track is formed in a bottom portion of said container body.

16. The portable storage container as defined in claim 12, wherein said container body further includes a releasable seat belt pass-through latch assembly provided on said container body for releasably engaging a seat belt of the vehicle for securing said container body to the vehicle.

17. The portable storage container as defined in claim 16, wherein said releasable seat belt pass-through latch assembly is provided at a bottom portion of said container body.

18. The portable storage container as defined in claim 16, wherein said releasable seat belt pass-through latch assembly includes a latch member pivotally mounted relative to said container body for releasably engaging said container body.

19. The portable storage container as defmed in claim 18, wherein said latch member is formed with a seat belt channel provided for supporting the seat belt in said seat belt pass-through latch assembly, said seat belt channel is formed on an inner surface of said latch member facing said container body.

20. A portable storage container provided to be used in a vehicle, said portable storage container comprising:
a container body defining a storage compartment and an opening therein;
a lid member provided for enclosing said opening of said container body;
a releasable seat belt pass-through latch assembly provided on said container body for releasably engaging a seat belt of the vehicle for securing said container body to the vehicle; and
at least one mount bracket for mounting said container body to the vehicle.

21. The portable storage container as defined in claim 20, wherein said releasable seat belt pass-through latch assembly is provided at a bottom portion of said container body.

22. The portable storage container as defined in claim 20, wherein said releasable seat belt pass-through latch assembly includes a latch member pivotally mounted relative to said container body for releasably engaging said container body.

23. The portable storage container as defined in claim 22, wherein said latch member is formed with a seat belt channel provided for supporting the seat belt in said seat belt pass-through latch assembly.

24. The portable storage container as defined in claim 23, wherein said seat belt channel is formed on an inner surface of said latch member facing said container body.

25. The portable storage container as defined in claim 20, wherein said at least one mount bracket is retractable between stowed position and an operating position.

26. The portable storage container as defined in claim 25, wherein said at least one mount bracket in said stowed position is disposed within said container body.

27. The portable storage container as defined in claim 26, wherein said container body has at least one groove track retractably receiving said at least one mount bracket for sliding movement between said stowed position and said operating position.

28. The portable storage container as defined in claim 27, wherein said at least one groove track is formed in a bottom portion of said container body.

29. The portable storage container as defined in claim 20, further including a refrigeration/heating unit for selectively cooling or warming said storage compartment.

30. The portable storage container as defined in claim 29, further including at least one electrical battery for supplying electrical energy to said refrigeration/heating unit.

31. The portable storage container as defined in claim 30, wherein said at least one electrical battery is rechargeable.
